(19) United States
(12) Patent Application Publication
(10) Pub. No.: US 2025/0072329 A1
(43) Pub. Date: Mar. 6, 2025

(54) WINDROW MATERIAL THROUGHPUT ESTIMATION SYSTEM

(71) Applicant: Deere & Company, Moline, IL (US)

(72) Inventors: Mohan A. Vadnere, Pune (IN); Mahesh Somarowthu, Pune (IN); Darin L. Roth, Batavia, IA (US)

(21) Appl. No.: 18/457,060

(22) Filed: Aug. 28, 2023

(51) Int. Cl. A01D 57/20; A01D 41/127; A01D 57/06

(52) U.S. Cl. CPC A01D 57/20; A01D 41/1274; A01D 57/06

(57) ABSTRACT

Systems and methods for estimating throughput of a crop material and controlling a belt speed of a cross conveyor. A conveyor can convey, and discharge, cut crop material from a merger device. A first sensor coupled to the conveyor provides information indicative of a weight or mass of the crop material on the conveyor, while another sensor can provide information regarding the speed at which the conveyor is operating. Such speed and weight or mass information can, along with calibration factors, be used to estimate a throughput of the crop material, including a rate at which crop material is being discharged from the merger device. The throughput estimation and information relating to the location and speed of travel of the associated agricultural vehicle, location of another windrow, target location for the discharged crop material, and selected windrow parameters can also be used to control the speed of the conveyor.

### FIELD OF THE DISCLOSURE

The present disclosure generally relates to systems and methods for windrow formation and collection, and more specifically to estimating throughput of crop material by windrowers.

### BACKGROUND

At least certain types of agricultural crops can be cut by an agricultural vehicle and deposited on a ground surface with other cut crop material to form windrows. Such agricultural vehicles, including, for example, windrowers, can be operated in attempts to form the windrows with particular profiles, including sizes relating to the width and vertical depth of the windrows. Further, in some instances, prior to collection of the cut crop material, the windrows can be sprayed in at least an attempt to alter the dry down time of the crop material within the windrow. Additionally, or alternatively, the windrow can be shaped in either an attempt to dry the cut crop material, or, alternatively, to prevent the cut crop material from becoming overly dry. Additionally, windrows can be arranged in at least an attempt to facilitate even distribution of the cut crop material when the cut crop material in the windrow is subsequently collected, such as, for example, by a baler, self-propelled forge harvester, among other agricultural vehicles. Such even distribution of the crop material that is being collected from the windrow, such as, for example, by a baler, can assist in preventing uneven consistencies and non-uniform shapes in the formation of crop bales by the baler.

### SUMMARY

The present disclosure may comprise one or more of the following features and combinations thereof.

In one embodiment of the present disclosure, an apparatus is provided for estimating a throughput of a crop material. The apparatus can include at least one conveyor having a conveyor belt and a driver, the driver adapted to provide a force for a rotational displacement of the conveyor belt. The apparatus can also include a first sensor coupled to the at least one conveyor. Additionally, a memory device can be coupled with at least one processor, the memory device including instructions that when executed by the at least one processor can cause the at least one processor to estimate, from information obtained by the first sensor, at least one of a weight and a mass of the crop material on the conveyor belt and identify a speed at which the crop material is being conveyed by the at least one conveyor. Additionally, the memory device can further include instructions that when executed by the at least one processor can cause the at least one processor to estimate, using the weight or the mass of the crop material and the speed, the throughput of the crop material.

In another embodiment, an apparatus is provided for controlling a speed at which a crop material is conveyed along the apparatus. The apparatus can include at least one conveyor having a conveyor belt and a driver, the driver being adapted to provide a force for a rotational displacement of the conveyor belt. The apparatus can also include a first sensor coupled to the at least one conveyor. Additionally, a memory device can be coupled with at least one processor, the memory device including instructions that when executed by the at least one processor can cause the at least one processor to estimate, from information obtained by the first sensor, at least one of a weight and a mass of the crop material on the conveyor belt and identify a target location at which the crop material discharged from the at least one conveyor is to be deposited. Further, the memory device can further include instructions that when executed by the at least one processor can cause the at least one processor to estimate, using at least one of the weight or the mass of the crop material and the target location, a speed to operate at least one of the driver and the conveyor belt, and generate a signal to facilitate operation of at least one of the driver and the conveyor belt at the speed.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1A illustrates a top view of an example of an agricultural vehicle depositing cut crop material on, or at a shoulder of, a previously formed windrow.

FIG. 1B illustrates a top view of an example of an agricultural vehicle depositing cut crop material to form a windrow adjacent to, and separate from, a previously formed windrow.

FIG. 2 illustrates a side perspective view of a portion of an agricultural vehicle having a merger device.

FIG. 3 illustrates a top side view of an exemplary throughput estimation system for a merger device.

FIG. 4 illustrates a block diagram of an exemplary harvesting system that includes an agricultural vehicle having a merger device and a throughput estimation system.

FIG. 5 illustrates an exemplary method for estimating a throughput of an agricultural vehicle in connection with a formation of a windrow.

FIG. 6 illustrates an exemplary method for controlling a belt speed of a cross conveyor of a merger device.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

A number of features described below may be illustrated in the drawings in phantom. Depiction of certain features in phantom is intended to convey that those features may be hidden or present in one or more embodiments, while not necessarily present in other embodiments. Additionally, in the one or more embodiments in which those features may be present, illustration of the features in phantom is intended to convey that the features may have location(s) and/or position(s) different from the locations(s) and/or position(s) shown.

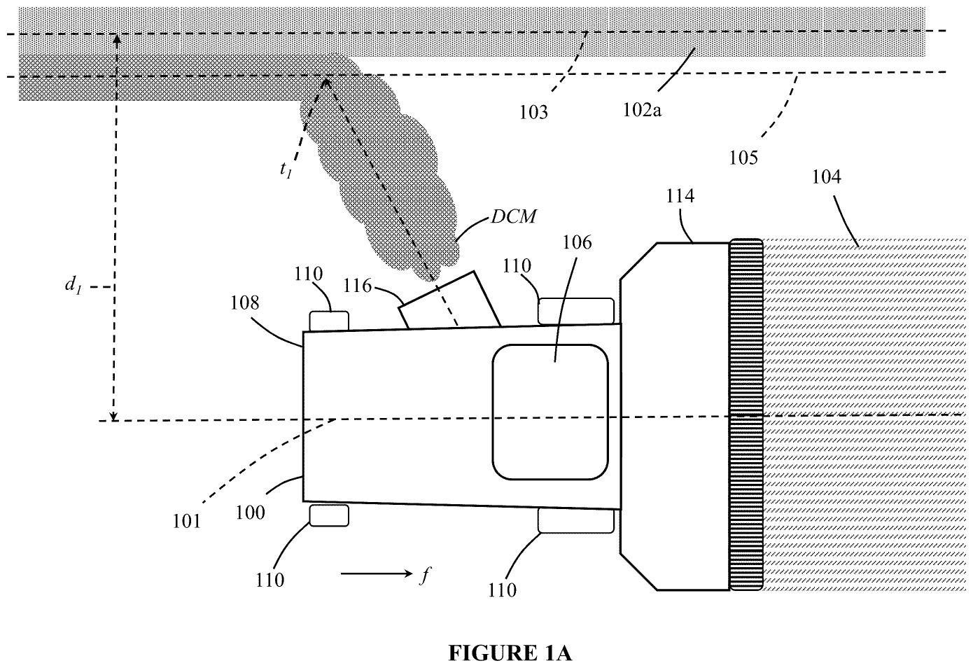

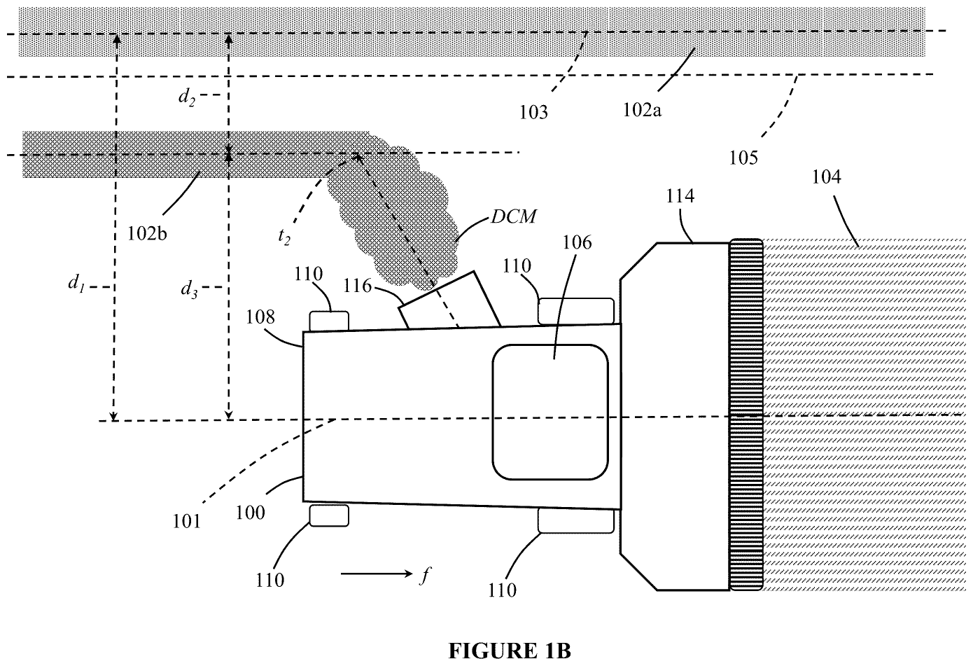

FIG. 1A illustrates a top view of an example of an agricultural vehicle 100 depositing cut crop material onto, or along a shoulder of, a previously formed windrow 102a that is positioned on a ground surface. FIG. 1B illustrates another example in which the agricultural vehicle 100 is depositing cut crop material on the ground surface to form a second windrow 102b generally parallel to, and offset from, the previously formed windrow 102a. While a variety of different agricultural vehicles can be utilized, according to the illustrated embodiment, the agricultural vehicle 100 is a windrower, including, but not limited to, a self-propelled windrower. However, the present disclosure is not limited to self-propelled equipment or windrowers, but also applies to other self-propelled and pull-type agricultural harvesting equipment, such as cutters, mowers, mower-conditioners, forage harvesters, and combines, among others. Additionally, a variety of different types of crops 104 can be cut by the agricultural vehicle 100, and be used to form one or more windrows 102a, 102b, including, but not limited to, alfalfa, hay, flax straw, cotton, silage, and salt march hay, among other crops.

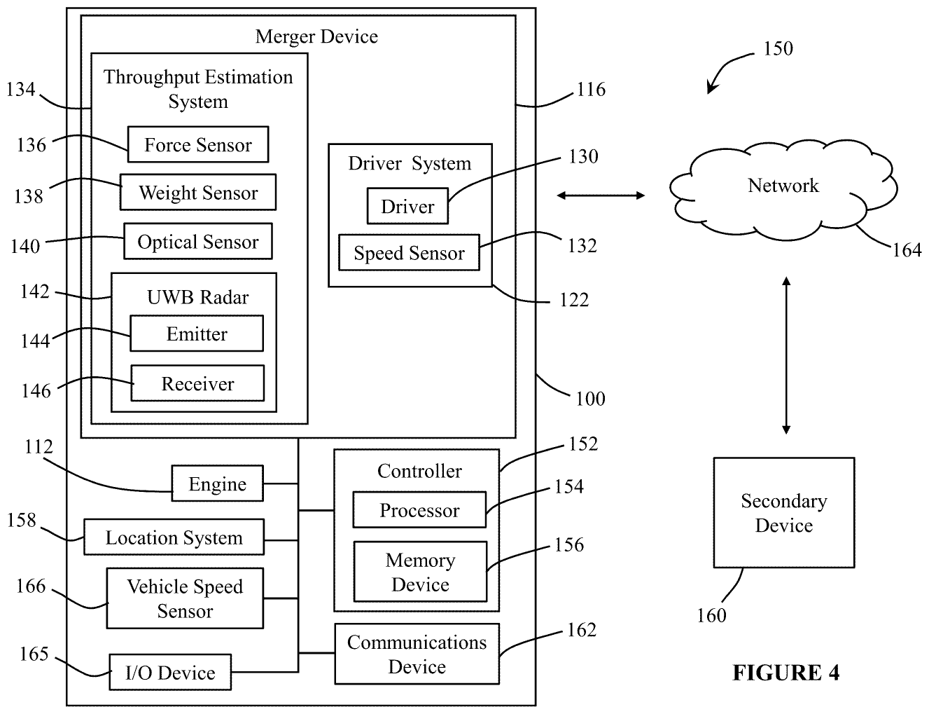

The agricultural vehicle 100 can include an operator compartment or cab 106 where an operator may direct or control the operation of the agricultural vehicle 100. The agricultural vehicle 100 can also include a frame 108 to which one or more ground engaging apparatuses 110, such as, for example, wheels or tracks, can be coupled. The agricultural vehicle 100 can also include a power source, and more specifically an engine 112 (FIG. 4), and a transmission operably coupled to one or more ground engaging apparatuses 110.

The agricultural vehicle 100 can also include a harvesting device or attachment, such as, for example, a harvesting header 114. According to certain embodiments, the harvesting header 114 can be a rotary header or a draper header. While the exemplary agricultural vehicle 100 illustrated in FIGS. 1A and 1B has a single harvesting header 114, the agricultural vehicle 100 can have multiple harvesting headers 114. The harvesting header 114 can include pickup devices, such as, for example, tines, forks, augers, conveyors, baffles, cutters, pre-cutter assemblies, and the like, or any combination thereof, that can either or both pick up or convey cut, or harvested, crop material.

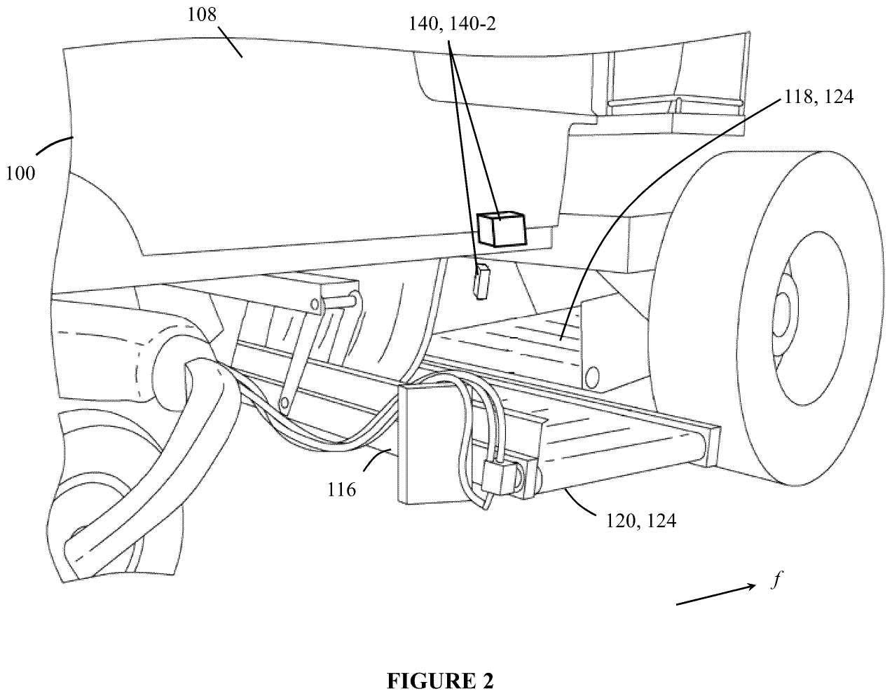

Referencing FIGS. 1A, 1B, 2, and 3, the agricultural vehicle 100 can also a merger device 116 having one or more conveyors 118, 120. Additionally, according to certain embodiments, the merger device 116 can be at least vertically displaced between a raised, non-operating position, and a lowered, operating position. When at the lowered, operating position, cut crop material can be delivered either directly or indirectly, from the harvester header 114 to the merger device 116. For example, according to the exemplary illustrated embodiment, the merger device 116 has two conveyors 118, 120, namely a first conveyor 118 and a second, cross conveyor 120. The first conveyor 118 can receive cut, or harvested, crop material from the harvesting header 114 and convey the cut crop material to the cross conveyor 120. Alternatively, the merger device 116 can include one conveyor, namely the cross conveyor 120. According to such embodiments, in the absence of the first conveyor 118, the cross conveyor 120 can be positioned and configured to receive the harvested cut crop from the harvester header 114.

The cross conveyor 120 is positioned and oriented to dispense harvested crop material from a side of the agricultural vehicle 100. For example, according to the embodiment shown in FIG. 1A, relative to the forward direction of travel (as indicated by the “f” direction in FIG. 1A) the merger device 116 is configured to dispense the cut crop material (identified as “DCM” in FIGS. 1A and 1B) generally from a left side of the agricultural vehicle 100. However, the merger device 116 can also be configured to dispense the crop material generally from the right side, front side, or rear side of the agricultural vehicle 100, among any other lateral or longitudinal portions or locations of the agricultural vehicle 100, as well as any angular positons therebetween.

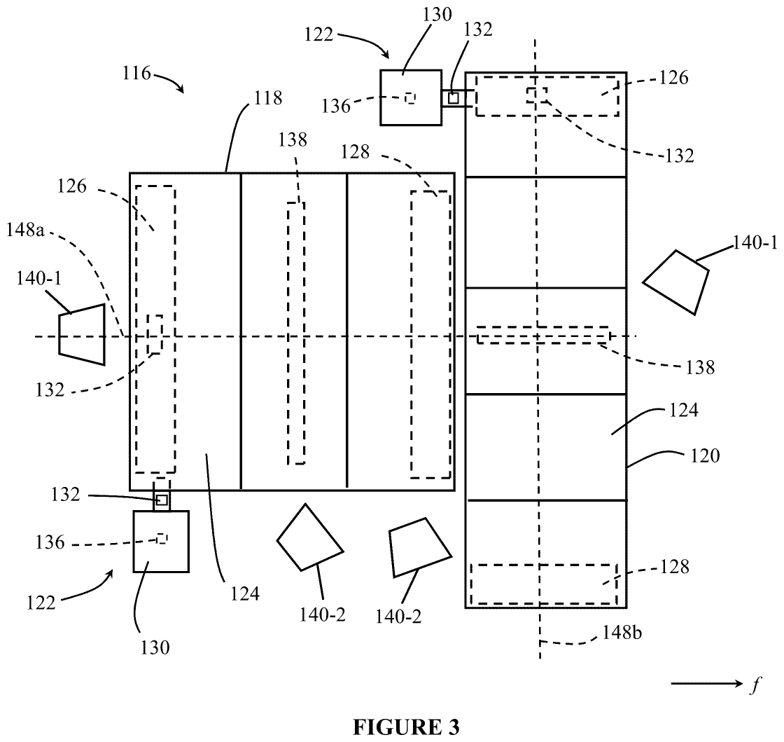

Referencing FIG. 3, according to certain embodiments, each conveyor 118, 120 is a powered or motored conveyor, and thus can include an associated driver system 122. Additionally, according to certain embodiments, the conveyor 118, 120 can include a conveyor belt 124 that can extend around at least a driver roller 126 and an idler roller 128. The driver system 122 can include a driver 130 that is configured to provide a force that can drive rotational displacement of at least the driver roller 126. A variety of different types of devices can be utilized as the driver 130, including, but not limited to electric motors, hydraulic actuators, and pneumatic actuators, among other forms of drivers. More specifically, according to certain embodiments, the driver 130 is a variable frequency drive motor, while, according to other embodiments, the driver 130 is a hydraulic actuator that is fluidly coupled to a hydraulic pump.

The belt 124 of the conveyor 118, 120 can have a generally continuous loop configuration. An interior side of the belt 124 can, at one end of the belt 124, be positioned against, or otherwise adjacent to, the driver roller 126, and the other end of the belt 124 can be positioned against, or otherwise adjacent to, the idler roller 128. Further, the driver roller 126 and the idler roller 128 can be spaced apart by a distance that can assist in the belt 124 having a particular tension or tautness. There may also be one or more other rollers, plates, or supports positioned between the driver roller 126 and the idler roller 128 that can assist in guiding the rotational movement of the belt 124, support the belt 124, or support the weight of the crop material that may be on the belt 124, as well as combinations thereof. The driver roller 126 can directly or indirectly engage the belt 124 in a manner in which at least a portion of a rotational force provided to the driver roller 126 by the driver 130 can be transferred from the driver roller 126 to the belt 124. Thus, at least a portion of the force provided by the driver 130 can be used to drive the displacement of the belt 124 about the driver roller 126, and thus also facilitate rotational displacement of the belt 124 about the idler roller 128.

According to certain embodiments the driver system 122 can also include one or more sensors, including, but not limited to, a speed sensor 132, that can provide information regarding the operation of the driver 130. The speed sensor 132 can, for example, be a Hall-effect sensor, eddy-current proximity sensor, magnetic sensor, or a fluid flow sensor (e.g., pilot tube, Bernoulli equation, etc.) among other sensors, that can be used to detect, for example, a rotational speed of a rotor of the driver, among other portions of the driver 130. Additionally, or alternatively, a speed sensor 132 can be located on the driver roller 126 or belt 124, among other locations, so as to detect the rotational speed of the driver roller 126 or belt 124 that is directly, or indirectly, coupled to the driver 130. The speed at which at least the driver 130 drives displacement of the belt 124 of the cross conveyor 120 can impact characteristics associated with the discharge or expelling of crop material from the cross conveyor 120, and thus from the merger device 116, and onto the ground surface or another windrow 102a. For example, as discussed below, the speed at which the driver 130 is operating, as well as the tilt or pitch of the belt 124 of the cross conveyor 120, can impact the distance crop material may travel away from the merger device 116 or agricultural vehicle 100, when the crop material is discharged from the merger device 116. Such distances can at least partially impact one or more, if not all, of the location, shape, width, and depth, among other characteristics, of the windrow(s) 102a, 102b being formed by the crop material that is discharged from the merger device 116, and moreover, from the cross conveyor 120.

The merger device 116 or agricultural vehicle 100 can also include a throughput estimation system 134 that can be utilized to estimate an amount of throughput of harvested cut crop material that is/has passing/passed through the merger device 116. Moreover, such crop material throughput information can provide an estimation of an amount of crop material in the windrows 102a, 102b that were formed by the crop material that was discharged from the merger device 116. Additionally, the throughput estimation system 134 can provide an indication of the locations of different quantities of crop material within a windrow 102a, 102b, or within different windrows 102a, 102b, in the field. Such information can be utilized for a variety of logistic purposes. For example, information provided by the throughput estimation system 134 can assist with planning subsequent agricultural operations that can utilize the cut crop material within the windrows 102a, 102b, including operations involving balers and forage harvesters. Moreover, such information can provide an indication of a quantity of bales that can be anticipated to be formed from the estimated quantity of crop material in the windrows 102a, 102b. An estimated bale quantity can also be used to estimate a length or quantity of bale wrap, twine, or ties that may need to be available for use with a baler(s) when baling the cut crop material in the windrows 102a, 102b. Information regarding bale quantity can also provide an indication of the number of trailers that may be needed for forage filing, as well as the potential nutritional content of the crop material within the bales, among other information.

According to certain embodiments in which the driver 130 is an electric motor, throughput estimation system 134 can include a driver force sensor 136 that can be utilized to detect a load, or change in a load, on the driver 130. For example, the load on the driver 130, and thus the power utilized by the driver 130 in providing a force for rotational displacement of the belt 124, can increase from a base level, such as, for example, when little or no crop material is on the belt 124, to a higher level upon the placement, or increase, of crop material on the belt 124. Thus, an increase in the weight of the crop material on the belt 124 of the cross conveyor 120 can increase a load on the driver 130, which can be detected by the driver force sensor 136. Accordingly, the driver force sensor 136 can detect the load, or changes in the load, on the driver 130 that is associated with the weight, or changes in the weight, of the crop material on the belt 124 of the cross conveyor 120. Such changes in load, or detected level of load, as detected by the driver force sensor 136, can be correlated to a weight or mass of the crop material on the belt 124 of the cross conveyor 120. A similar driver force sensor 136 can also be used with the driver 130 of the first conveyor 118, and provide similar information with respect to the load, or changes in load, on the driver 130 of the first conveyor 118 that can be used to determine the weight or mass of the crop material on the belt 124 of the first conveyor 118.

Further, according to certain embodiments in which the driver 130 is a hydraulic or pneumatic actuator, the driver force sensor 136 can be a pressure sensor that can be utilized to detect changes in the hydraulic fluid or gas within the hydraulic or pneumatic actuator or associated hydraulic or pneumatic circuit. For example, with little or no crop material on the belt 124 of the cross conveyor 120, the pressure of the hydraulic fluid being used by the hydraulic actuator, or otherwise part of the associated hydraulic circuit, can provide a base pressure value. However, increases in the weight of crop material on the belt 124 of the cross conveyor 120 increase can cause associated increases in the pressure of the hydraulic fluid. Thus, such increases in pressure, or in view of the base pressure level, can be correlated to a weight or mass of the crop material on the belt 124. A similar driver force sensor 136 can also be used with the driver 130 of the first conveyor 118, and provide similar information with respect to the pressure, or changes in pressure, of the hydraulic fluid or gas being used with the associated driver 130, or, in this scenario, hydraulic or pneumatic actuator. Again, as with the cross conveyor 120, changes in the pressure of the hydraulic fluid or gas of the driver 130 being used with the first conveyor 118, as detected by the driver force sensor 136, can provide an indication of the weight or mass of the crop material on the belt 124 of the first conveyor 118.

Additionally, or alternatively, the throughput estimation system 134 can include at least one weight sensor or transducer 138 (collectively referred to herein as weight sensor 138) that can indicate, or provide information used to determine, a weight or mass of the harvested crop material on the belt 124. For example, as seen in FIG. 3, at least one weight sensor 138 can be coupled to the belt 124 of the cross conveyor 120. In the illustrated embodiment, a weight sensor 138 can be positioned directly beneath a portion of the belt 124 on which crop material is located, among other locations. The weight sensor 138 can convert a mechanical force, such as, for example, one or more of a load, weight, tension, compression, or pressure on the belt 124, or other portion of the conveyor 118, 120, into another physical variable that can correspond to a weight or mass of the crop material on the belt 124. According to certain embodiments, the weight sensor 138 comprises one or more load cells.

The throughput estimation system 134 can also include one or more speed sensors 132. Information provided by the speed sensors 132 can be used with information provided by at least the weight sensor 138 to provide information indicating, or used to estimate, a throughput of the crop material in the form of rate at which an amount of crop material is being either or both propelled by, or dispensed from, the merger device 116. Such throughput information can be expressed in a variety of manners, including, for example, in terms of kilograms or pounds of crop material being dispensed from the merger device 116 per second, among other units of measurement. Further, such information can be utilized to estimate the corresponding amount of crop material in a windrow 102a, 102b, or different amounts of crop material in different portions of the same windrow 102a, 102b. According to certain embodiments, at least a portion of the speed sensor 132 can be coupled to the belt 124. Additionally, or alternatively, the speed sensor(s) 132 can be positioned to either or both a driver 130 or a roller 126, 128 of the associated conveyor 118, 120.

The throughput estimation system 134 can also include one or more optical sensors 140. The optical sensor 140 can provide information that can be used to estimate a volume of crop material on a belt 124 of a conveyor 118, 120, being discharged from the conveyor 118, 120, or that has been discharged from the merger device 116 prior to the discharged crop material landing, or otherwise being deposited, on the ground surface or other, previously formed windrow 102a.

A variety of different types of cameras, sensors, or radar can be utilized for the optical sensor 140, including, but not limited to, stereo depth cameras, stereo sensors, time of flight sensors, RGBD (red, green, blue, depth) cameras, three-dimensional sensors, three-dimensional cameras, structural light sensors, or light detection ranging sensors, as well as combinations thereof, among others. For example, such optical sensors 140 can be utilized to obtain pixel information that can be used to estimate a height, width, and length of one or more portions or segments of the crop material passing along a conveyor 118, 120. According to certain embodiments, the optical sensor 140 can utilize a light beam and a camera. According to such an embodiment, a volume of crop material can be determined using detected information of locations, and the associated sizes of the locations, at which light from the light beam is either broken or not broken, as well as a combination thereof.

Additionally, or alternatively, according to certain embodiments, the optical sensor 140 can comprise a radar system, including, but not limited to, an ultra-wideband (UWB) radar system 142. The UWB radar system 142, or other radar system, can include an emitter 144 that can transmit signals or information over a bandwidth that is, for example, around or greater than 500 megahertz (MHz), as well as a receiver 146 that detects the reflected UWB signals. While FIG. 4 illustrates a representation of a UWB radar system 142, other embodiments may utilize other types of radar systems.

A variety of other types of information can also be used to determine the volume of crop material being at least discharged from the merger device 116 prior to the discharged crop material landing, or otherwise being deposited, on the ground surface or other, previously formed windrow 102a. Further, at least certain types of information can be provided from sources external to the agricultural vehicle 100. For example, information regarding the speed of the wind surrounding ambient environment, and associated impact on the disbursement the discharged crop material, or associated impact on the information obtained via use of the optical sensor 140 can be a factor taken into consideration with respect to at least the volume determination. According to certain embodiments, such wind speed information can be detected, communicated, or retrieved from a weather related source that is external, and possibly unrelated to, the agricultural vehicle. Additionally, or alternatively, the speed at which the agricultural vehicle 100 is traveling at least at the time one or more images of discharged crop material can also be a factor used in determining the volume of crop material discharged from the merger device 116 from the image(s) captured by the optical sensor 140. Further, information from an external source can be communicated to one or more systems of the agricultural vehicle 100 relating to the physiology of the crop material being, or that has been, discharged from the merger device 116. Such crop physiology information can include, for example, information regarding plant definition or type, leaf count, and stem branches, among other information. At least certain identified features of the crop physiology can be utilized as a factor or consideration when at least attempting to determine the volume of crop material from information captured in one or more image(s) that may be obtained via use of the optical sensor 140.

According to certain embodiments, a determination of a volume, as well as a mass or weight, of the harvested crop material passing through the merger device 116, or being discharged from the merger device 116, can provide an indication of a density of the associated crop material. An estimation of density can provide a variety of information regarding the harvested crop material. For example, density information can be utilized to estimate a moisture content of the harvested crop material. Density information can also be used for at least planning for other, later agricultural operations, including for example, baling and storage planning, among other operations. Alternatively, according to certain embodiments, information provided by the UWB radar system 142 can be utilized to determine the density of the crop material on or being dispensed from the merger device 116.

The optical sensor 140 can be positioned at a variety of locations about the agricultural vehicle 100 or merger device 116. For example, referencing FIG. 3, for one or more of the conveyors 118, 120, a first optical sensor 140-1 can be positioned at a location at which the first optical sensor 140-1 can obtain one or more images, including still images or video, of cut crop material on the associated belt 124. Additionally, or alternatively, for one or more of the conveyors 118, 120, a second optical sensor 140-2 can be positioned at a location at which the second optical sensor 140-2 can obtain one or more images, including still images or video, of crop material that is leaving, or being discharged, from the associated belt 124 or conveyor 118, 120. For example, with respect to the exemplary embodiment shown in FIG. 3, one or more second optical sensors 140-2 can captured one or more images of crop material leaving the belt 124 of the first conveyor 118 before, or during, a transfer of the crop material from the first conveyor 118 to the cross conveyor 120. Similarly, one or more second sensors 140-2 can capture one or more images of crop material before, as or after the crop material is discharged from the cross conveyor 120, and thus from the merger device 116.

The optical sensors 140-1, 140-2 can be coupled to the merger device 116 or the agricultural vehicle 100, including to the frame 108 of the agricultural vehicle 100. Additionally, FIG. 3 illustrates the first optical sensor 140-1 associated with the first conveyor 118 being generally aligned with a longitudinal axis 148a, and the associated second optical sensor 140-2, as well as the first and second optical sensors 140-1, 140-2 associated with the cross conveyor 120, being angularly offset from the longitudinal axis 148a, 148b of the associated conveyor 118, 120. However, the optical sensors 140-1, 140-2 can be positioned at a variety of locations, including locations that align, or do not, align with the longitudinal axis 148a, 148b of the associated conveyor 118, 120, as well as various combinations thereof.

FIG. 4 illustrates a block diagram of an exemplary harvesting system 150 that includes an agricultural vehicle 100 having a merger device 116. The throughput estimation system 134 and the driver system 122 are illustrated in the exemplary embodiment shown in FIG. 4 as being part of the merger device 116. However, according to other embodiments, one or both of the throughput estimation system 134 and the driver system 122 may not be part of the merger device 116, and instead can be separate systems or parts of other systems of the agricultural vehicle 100.

The agricultural vehicle 100 can include a controller 152 having one or more processors 154 that can follow instructions, including control instructions, contained with, or are part of, one or more memory devices 156, including, for example, a non-transitory machine-readable medium. The exemplary embodiment shown in FIG. 4 illustrates the controller 152 as being separate from at least the throughput estimation system 134, driver system 122, and merger device 116. However, according to other embodiments, one or more, if not all, of at least the throughput estimation system 134, driver system 122, and merger device 116 can have a dedicated controller that is at least similar to the controller 152 that is herein illustrated and discussed.

The agricultural vehicle 100 can also include a location system 158, such as, for example, a global positioning system (GPS), among other location systems. The location system 158 can be operated to provide a detailed indication of the location of the agricultural vehicle 100, particularly as the agricultural vehicle 100 traverses across the field. According to certain embodiments, the location system 158 can include a receiver that can receive information from an external source that can indicate the particular location of the agricultural vehicle 100, including, for example, via location coordinates. The location of the agricultural vehicle 100, as well as information regarding the operation of the merger device 116, including the throughput estimation system 134 and the driver system 122, can be utilized to provide an indication of a location of a windrow(s) 102a, 102b being formed by the agricultural vehicle 100.

For example, information regarding the speed at which the driver 130 is being operated, the speed at which the belt 124 of the cross conveyor 120 is rotating, the orientation of the cross conveyor 120, or the speed at which the agricultural vehicle 100 is traveling, as well as combinations thereof, among other information, can be used by the processor 154 to estimate the location harvested crop material is being deposited onto the ground surface of the field. Additionally, the controller 152 can be configured to not only receive information regarding the speed of the at which the agricultural vehicle 100 is traveling, as provided, for example, via a vehicle speed sensor 166, but can also issue signals for an engine 112 of the agricultural vehicle 100 that can adjust the speed of travel of the agricultural vehicle 100.

Knowledge of the location at which the discharged harvested crop is being deposited onto the ground surface can indicate the location of the associated windrow 102a, 102b being formed, or supplemented, by the deposited crop material. Additionally, as discussed below, knowledge of the location of an existing windrow 102a can be used to determine the location at which an agricultural vehicle 100 that did, or did not, form that windrow 102a is to deposit crop material so as to increase a size of the existing windrow 102a, as shown for example in FIG. 1A. Additionally, or alternatively, information regarding the location of the previously formed windrow 102a can be used in connection with determining the location at which the agricultural vehicle 100 is to form another windrow 102b, as illustrated for example in FIG. 1B. Such location information for the windrows 102a, 102b formed by the agricultural vehicle 100, or other agricultural vehicles, can be stored in the agricultural vehicle 100 that formed the windrow 102a. 102b, as well as stored at a secondary device 160. In some instances, information stored at the secondary device 160 regarding the location of previously formed windrows 102a location can be retrieved by an agricultural vehicle 100 in connection with determinations as to the location at which the agricultural vehicle 100 is to deposit harvested crop material in the field to supplement the previously formed windrow 102a or form a new windrow 102b.

The agricultural vehicle 100 can also include a communications device 162 that can communicate information to, as well as receive information from, other components, equipment, or vehicles of the harvesting system 150. The communications device 162 can be embodied as hardware, firmware, software, virtualized hardware, emulated architecture, and/or a combination thereof. According to certain embodiments, the communications device 162 can comprise a transceiver that is configured to wirelessly communicate information, as well as receive information, that may pertain to, or assist, in determining either or both throughput information or windrow 102a, 102b information.

For example, as seen in FIG. 4, the communications device 162 can be communicatively coupled to a network 164, including, for example, via internet, cellular, and/or Wi-Fi networks. Such connection to the network 164 can facilitate an exchange of information, including information between the agricultural vehicle 100 and the secondary device 160, including a central database, cloud based server, or other agricultural vehicles, as well as combinations thereof. As previously mentioned, such exchanges of information can, for example, relate to one or more windrows 102a that may have been formed by another agricultural vehicle. Such information can include, but is not limited to, the location, and size or shape, among other profile information, of one or more portions of a windrow 102a, 102b as well as various combinations thereof, among other information. Such communications can also relate to storing throughput information, including information indicating, or that can be used to estimate, the quantity, weight, mass, volume, or density of crop material contained in windrows 102a, 102b, which, as discussed above, can at least be utilized for a variety of logistic purposes.

The controller 152 can also be coupled to one or more input/output (I/O) devices 165 of the agricultural vehicle 100. The I/O device 165 can take a variety of forms, including, for example, be or include a monitor, screen, touch screen, keyboard, keypad, mouse, switch, joystick, or button, as well as any combination thereof, among other types of I/O devices. According to certain embodiments, the I/O device 165 can be positioned in the operator cab 106 of the agricultural vehicle 100. Additionally, or alternatively, the I/O device 165 can be part of a mobile or handheld device or other device that can be remotely located from the agricultural vehicle 100.

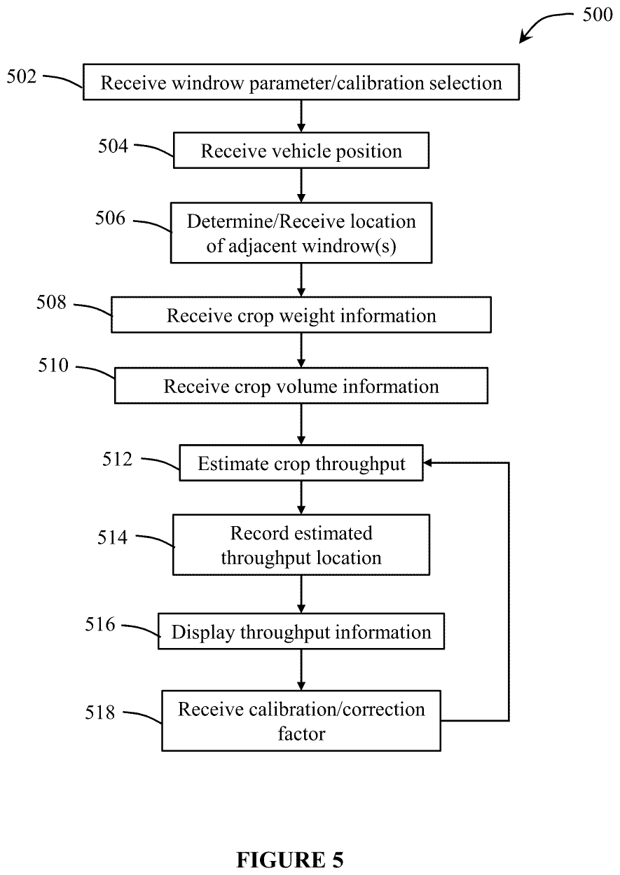

FIG. 5 illustrates an exemplary method 500 for estimating a throughput of an agricultural vehicle 100 in connection with a formation of a windrow 102a, 102b. The method 500 is described below in the context of being carried out by the illustrated exemplary harvesting system 150. However, it should be appreciated that method 500 can likewise be carried out by any of the other described implementations, as well as variations thereof. Further, the method 500 corresponds to, or is otherwise associated with, performance of the blocks described below in the illustrative sequence of FIG. 5. It should be appreciated, however, that the method 500 can be performed in one or more sequences different from the illustrative sequence. Additionally, one or more of the blocks mentioned below may not be performed, and the method can include steps or processes other than those discussed below.

At block 502, information can be received regarding parameters for the crop material or the windrow 102a, 102b and calibration of the throughput estimation system 134. Such information can be provided in a variety of different manners, including, for example, via input by an operator using the I/O device 165. Moreover, such selection can involve the operator inputting information or selecting one or more parameters from a list or menu of options. Windrow parameters can include information regarding the size and shape, among other profile information, or location, as well as combinations thereof, among other parameters, for the windrow 102a, 102b that is to be formed or supplemented via use of the agricultural vehicle 100. Additionally, parameters for the crop material cam be determined via an identification of a crop material type. For example, an identification of a crop material type, such as, for example, by the operator, can automatically result in an identification of certain parameters associated with that identified crop type, including, but not limited to, the population density for the associated plant, average stem count per plant, and/or stem height, among other possible information, that may further assist in determining a generally accurate estimate of yield for an associated field.

Calibration information can also include information that can provide, or be used to derive, an indication of the moisture content of the crop material being harvested, as well as used in connection with determining the density of the harvested crop material. For example, information identifying the type of crop being cut, including plant or hybrid type, the current season in which the agricultural operation is being performed, weather conditions, or the field or field location in which the crop material is being harvested, as well as combinations thereof, among other information, can be used to at least estimate the moisture content of the crop material. Such moisture content information can also be sensed from a moisture sensor or otherwise inputted by the operator. The moisture content information, among other parameters, can be utilized in a variety of manners, including, for example, in connection with information provided by the weight sensor 138 or driver force sensor 136. Moreover, weight information provided by the weight sensor 138 or driver force sensor 136 can be influenced by the moisture content of the crop material. Thus, according to certain embodiments, the controller 152, including the processor 154, can utilize calibration information, or associated user input selections, to make appropriate adjustments to the weight information so to account for moisture content, and thus allow for a more accurate indication of the weight or mass of the crop material. Moreover, such adjustments or correlations may, for example, include minimizing, or attempting to discount, the influence the moisture content of the crop material has on the information provided by the weight sensor 138 or driver force sensor 136, and thereby obtain a more accurate indication of the amount of crop material being discharged by the merger device 116.

At block 504, the location system 158 can be utilized to receive the current location of the agricultural vehicle 100. Such communication to the location system 158 can, according to certain embodiments, utilize the communications device 162. For example, at block 504, GPS coordinates can be retrieved or identified to indicate the current location of the agricultural vehicle 100. Additionally, at block 506, the communications device 162 or location system 158 can also be used to obtain location information for a previously formed windrow 102a, including GPS coordinates for at least portions of, if not corresponding to the entirety of, the previously formed windrow 102a. According to certain embodiments, the location information can be obtained via use of the network from a secondary device 160, such as, for example, another agricultural vehicle 100 or a database. Alternatively, if the agricultural vehicle 100 forming the current windrow 102b also formed the previous windrow 102a, such location information for the previously formed windrow 102a can be stored in the memory device 156 or location system 158 of the agricultural vehicle 100, among other portions of the agricultural vehicle 100.

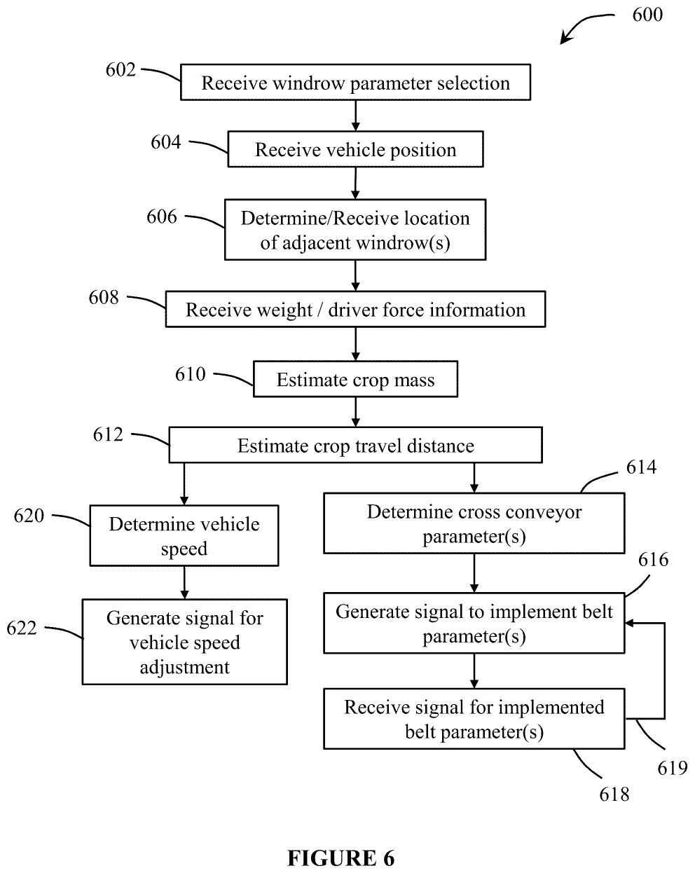

With respect to instances in which the agricultural vehicle 100 retrieves location information for a previously formed windrow 102a from the secondary device 160, the location information for the previously formed windrow 102a can be provided in a variety of different manners. For example, such location information for the previously formed windrow 102a can correspond to one or more locations corresponding to the entire length, or certain points or segments, of the previously formed windrow 102a. Additionally, the location information for the entirety of the previously formed windrow 102a can be communicated together to the agricultural vehicle 100, or, alternatively, can be communicated continuously or at certain time intervals based on the current or predicted upcoming location of the agricultural vehicle 100. As discussed below, particularly with regard to FIG. 6, according to certain embodiments, such information regarding the location of the previously formed windrow 102a and the location of the agricultural vehicle 100 can be utilized in determining a location at which the agricultural vehicle 100 is, via the merger device 116, to deposit crop material for a windrow 102b that is currently being formed, or alternatively, to supplement the previously formed windrow 102a. Moreover, such location information can be utilized to determine operation parameters for the merger device 116 such that the crop material currently being dispensed by the agricultural vehicle 100 is deposited onto, or next to, the previously formed windrow 102a, or forms another windrow 102b at a particular location relative to the previously formed windrow 102a, as discussed below.

At block 508, the throughput estimation system 134 can be used to obtain a weight or mass of the crop material that is on one or more belts 124 of the conveyors 118, 120. As discussed above, such weight or mass information for the crop material can be obtained in a variety of different manners, including, for example via use of the information provided by either or both one or more driver force sensors 136 or weight sensors 138, as discussed above. According to certain embodiments, the weight or mass information obtained at block 508 can be provided to the controller 152, including provided for use by the processor 154 of the controller 152. Moreover, according to certain embodiments, the weight information provided to the controller 152 can be provided in the form of a mechanical force, such as, for example, a load, weight, tension, compression, or pressure that the controller 152, including the processor 154, can convert into another physical variable, such as either or both crop material weight or mass. Additionally, or alternatively, at block 510, the controller 152 can receive information regarding the volume or density of the crop material either on or dispensed from the merger device 116. As previously discussed, such volume information can be obtained in a variety of different manners, including via use of one or more optical sensors 140, 142.

Add block 512, the controller 152, including the processor 154, can utilize at least the information provided at either or both blocks 508 and 510, as well as the parameter and calibration information provided at block 502, to estimate a crop throughput. For example, according to certain embodiments, using the information provided from blocks 502 and 508, the controller 152 can provide an indication of the total weight or mass of crop material that has, up to that point in time, been dispensed from the merger device 116 and deposited into a windrow 102a, 102b. According to such embodiments, the weight or mass information provided at block 508 can be adjusted using information provided at block 502, including, for example, adjusted to account for the moisture content of the crop material, among other parameters or calibration factors. Additionally, the operator has the ability to selectively override or adjust such parameters or calibration factors at various times during the method 500, such as, for example, via use of the I/O device 165, as discussed below with respect to at least block 518.

According to such an embodiment, the crop throughput can provide a value that is increasing or accumulates as crop material continues to pass along, and from, the merger device 116 and is being deposited in a windrow 102a, 102b. Additionally, or alternatively, the crop throughput estimation provided at block 512 can provide a rate at which crop material is being dispensed from the merger device 116. For example, information provided by the either or both the weight sensor 138 or the driver force sensor 136, as well as from the speed sensor 132 of the driver system 122 can provide an indication of the weight or mass per unit of time that is being dispensed from the merger device 116. Thus, for example, according to current certain embodiments, the crop throughput estimation can be expressed in terms of kilograms or pounds of crop material per second, among other units of measurement, that is being dispensed from the merger device 116. For example, a wet, whole plant harvest at 10 tons per acre (tons/acre) and 20 acres per hour (acres/hr) equates to a throughput of 11 pounds per second (lbs/s). Further, according to certain embodiments, such information can be calibrated based at least on information provided at block 502.

Additionally, according to certain embodiments, the crop throughput estimation provided at block 512 can indicate a density of crop material being dispensed from the merger device 116. For example, information regarding the weight of the crop, as provided by block 508, the volume of crop material, as provided at block 510, and the type of crop material, as provided at block 502, among other information, can be used to determine the volume of crop material being dispensed from the merger device 116. Additionally, or alternatively, information provided by the UWB radar system 142 can be utilized to determine the density of the crop material at block 512, as previously discussed. Such density information can be utilized for a variety of other, downstream, operating processes. For example, such information can provide an indication of the equipment that may be utilized for bailing the crop material in the windrow 102a, 102b. Additionally, such density information, when used with other constituent measurements or information, can also be utilized to provide an indication of a nutritional value of the harvested crop material.

The estimated crop throughput can be recorded at block 514. Such recording can occur at a variety of different locations including, via use of the memory device 156 or at the secondary device 160. Further, such recording can occur at a variety of different time points, including continuously, at certain predetermined intervals, or upon completion of a windrow 102a, 102b or the associated harvesting operation, among other time periods. Additionally, information regarding the estimated crop throughput can be presented or otherwise made available to the operator at block 516. For example, a display in the operator cab 106 can provide or display information regarding the estimated crop throughput, as determined at block 512, as well as the weight, mass, volume, or density information, as well as combinations thereof, obtained using information from either or both blocks 508 and 510.

At block 518, the operator can have the opportunity to adjust or correct the parameters or calibration factors that were provided at block 502. For example, based on the estimated crop throughput information determined at block 512, and presented to the operator at block 516, the operator may determine that one or more calibration factors that were provided at block 502 are to be adjusted or corrected. Thus, for example, the operator may recognize that the agricultural vehicle 100 is entering an area of the field in which the moisture content of the crop is different than that of the prior area of the field. Additionally, or alternatively, the operator may determine that, from the previously estimated throughput information, the accuracy of the estimations may be improved by making an adjustment in the calibration or parameters. In such situations, the operator can utilize the I/O device 165 at block 518 to adjust one or more of the parameters or calibration factors that were inputted at block 502, among other possible parameters or calibration factors. Such adjustments can be implemented in the crop throughput estimations that are being, or are subsequently, being obtained at block 512. Such a method 500 can be continued until completion of the agricultural operation by the agricultural vehicle 100.

FIG. 6 illustrates an exemplary method 600 for controlling a belt speed of a belt 124 of a cross conveyor 120 of a merger device 116. The method 600 is described below in the context of being carried out by the illustrated exemplary harvesting system 150. However, it should be appreciated that method 600 can likewise be carried out by any of the other described implementations, as well as variations thereof. Further, the method 600 corresponds to, or is otherwise associated with, performance of the blocks described below in the illustrative sequence of FIG. 6. It should be appreciated, however, that the method 600 can be performed in one or more sequences different from the illustrative sequence. Additionally, one or more of the blocks mentioned below may not be performed, and the method can include steps or processes other than those discussed below.

At block 602, the controller 152, including, for example, the processor 154, can receive one or more windrow selection parameters. Such parameters can be inputted by the operator via use of the I/O device 165, and can correspond to either or both a windrow profile or a target location at which the merger device 116 is to deposit crop material. For example, the windrow parameter selection can include an indication of whether the merger device 116 is to deposit crop material onto, or against, an existing windrow 102a, such as shown for example in FIG. 1A. Alternatively, the windrow parameter selection can relate to a target location at which a windrow 102b is to be formed relative to another, previously formed windrow 102a, as shown, for example, by FIG. 1B. The windrow parameter selection can also relate to the width and or vertical height, among other profile information, for the windrow 102a, 102b. Moreover, as previously discussed, in certain instances, a profile for the windrow 102a, 102b can be selected, developed, or identified at block 602 based on a variety of factors, such as, for example, the moisture content of the crop material, the ambient temperature, potential sun exposure, or wind conditions, as well as combinations thereof, among other factors.

At block 604, the location system 158 can be used to determine or identify the location of the agricultural vehicle 100. Further, at block 606, the location of a previously formed windrow 102a can be retrieved for the controller 152 or processor 154, such as, for example, retrieved from the memory device 156 of the agricultural vehicle 100 or from the secondary device 160. As previously discussed, and as discussed below, the information provided by blocks 604 and 606 can be used by the controller 152 to determine a position of the agricultural vehicle 100 relative to a location at which crop material is to be deposited onto the field via operation of the merger device 116.

According to certain embodiments, at block 608, the controller 152, including the processor 154, can receive information from the driver force sensor 136 indicating, or used to determine, a load or pressure being exerted on the associated driver 130 or belt 124. As previously discussed, such information can be utilized to determine a weight or mass of the crop material that is on the belt 124. Additionally, or alternatively information regarding the weight or mass of the crop material on the conveyor belt 124 can be provided, or derived from information provided, by one or more weight sensors 138. Using the information provided at block 608, the controller 152, including the processor 154, can estimate a mass or weight of the crop material at block 610.

The information provided by blocks 602 through 610, among other information, can be used by the controller 152, including the processor 154, in determining the speed at which the driver 130 is to operate the belt 124 of the cross conveyor 120 such that crop material discharged from the merger device 116 reaches the target location, and has a profile that corresponds to the windrow parameter selection made at block 602. However, a variety of other information can also be used for determining the speed at which the driver 130 is to operate the belt 124, including, but not limited to, considerations related to windrow optimization, such as, for example, a target location for depositing discharged crop material and the associated belt discharge angle(s), among other considerations. Similarly, the information provided a blocks 602 through 610 can also be used by the controller 152, including the processor 154, in determining the speed at which the agricultural vehicle 100 is to travel so that the discharged crop material reaches the target location, and has a profile that corresponds to the windrow parameter selection made at block 602.

For example, FIG. 1A illustrates an example in which the target location corresponds to crop material being deposited on, or against, a previously formed windrow 102a. In such an example, the controller 152 can, at block 612, utilize information identifying the location of the previously formed windrow 102a (block 606), as represented, for example, by a windrow centerline 103. The controller 152 can also use the location of the agricultural vehicle 100 (block 604), as indicated by a vehicle centerline 101, to determine a distance (indicated by “d₁” in FIG. 1A) between the previously formed windrow 102a and the agricultural vehicle 100. Such distance information, as well as the selected target location, can be used by the controller 152, including the processor 154, to determine a target distance that the crop material (DCM) is to travel when discharged from the merger device 116 so as to reach the target location (indicated by “t₁” in FIG. 1A). In the illustrated location, the target location (t₁) is identified as being along a centerline 105. However, the target location can at a variety of other locations, as well as correspond to a variety of areas. Additionally, while the illustrated example demonstrates the windrow centerline 103 of the previously formed windrow 102a, and the centerline 105 associated with the target location being generally straight, the centerlines 103, 105 can extend in various directions, or along a collection of various directions. For example, according to certain embodiments, windrow centerline 103 of the previously formed windrow 102a can be curvilinear. In such situations, the controller 152 can determine target locations for the discharge of crop material from the merger device 116 such that the discharged crop material is positioned along a centerline 105 that also has a curvilinear shape.

Alternatively, referencing FIG. 1B, the windrow parameter selection information provided at block 602 can correspond to a distance at which a newly formed windrow 102b is to be separated from the previously formed windrow 102a, also referred to as an offset distance (indicated by “d₂” in FIG. 1i). In such a situation at block 612, the controller 152, including the processor 154, can utilize the agricultural vehicle 100 information (block 604), the information regarding the location of the previously formed windrow 102a (block 606), and the offset distance information (block 602) to determine a distance (indicated by “d₃” in FIG. 1B) at which the crop material is to be displaced from the merger device 116 to reach the associated target location (indicated by “t₂” in FIG. 1), Again, the according to certain embodiments, the target location may, or may not, be positioned at or along at least a portion of a target windrow centerline 105, or correspond to a variety of areas or regions.

Determinations as to the distance at which crop material discharged from the merger device 116 is to travel so as to reach the associated target location (t₁, t₂) can also be based on a variety of information. For example, for at least purposes of illustration, the distances (d₁, d₂, d₃) shown in FIGS. 1A and 1B are illustrated as being generally orthogonal to the direction of travel of the agricultural vehicle 100. However, the merger device 116, and moreover the cross conveyor 120, can be arranged at an angle that is not orthogonal to the direction of travel of the agricultural vehicle 100. Moreover, as shown in the examples provided by FIGS. 1A and 1, discharged crop material may travel from the merger device 116 to the associated target location along a path that may acute or obtuse to the direction of travel of the agricultural vehicle 100. Further, the cross conveyor 120 may or may not be tilted in the vertical direction, such as for example, in an upwardly or downwardly sloped direction. Thus, such angular orientations of the cross conveyor 120 can also be considered by the controller in the determination of the distance to which the crop material is to be displaced from the cross conveyor 120 so as to reach the associated target location.

Information regarding the distance at which the crop material is to be displaced from the merger device 116, as well as information regarding the weight of the crop material, can be used at block 614 by the controller 152 to determine parameters for the operation of the cross conveyor 120. Such cross conveyor parameters can relate to the speed or velocity at which the cut crop material, having the indicated weight or mass, is to travel when discharged from the merger device 116 such that the discharged crop material reaches the associated target location (t₁, t₂). Thus, such information can be utilized to determine either or both a speed at which the driver 130 is to be operated, or the speed at which the associated belt 124 is to be rotated, such that the cut crop material travels at the appropriate speed when discharged from the merger device 116. Accordingly, at block 616, the controller 152, including the processor 154, can generate a signal that is used to operate the driver 130 of the cross conveyor 120 in accordance with the cross conveyor parameter determined at block 614, including at the speed determined at block 614.

Additionally, according to certain embodiments, a feedback loop, as generally indicated by arrow 619, can be utilized to monitor and or verify that the driver 130 or belt 124 of the cross conveyor 120 is being operated in accordance with the parameter(s) that were determined at block 614. For example, the speed sensor 132 can be utilized to provide information to the controller 152 that can be used determine or verify whether the driver 130 or cross belt 124 is being displaced at a speed or rate that conforms to the cross conveyor parameter determined that was made at block 614. If the controller 152 determines that the driver 130 or cross belt 124 is/are not operating in accordance with the cross conveyor parameter determined at block 614, the controller 152 can issue an adjustment signal so that the operation of the driver 130 is adjusted in a manner that facilitates the speed of the driver 130 or cross belt 124 being in compliance with the previously determined cross conveyor parameter.

Additionally, in at least an attempt to obtain the profile for the windrow 102a, 102b identified at block 602, the controller 152 can determine a speed of travel for the agricultural vehicle 100 at block 620. Moreover, the controller 152 can use information regarding the estimated crop weight or mass, as determined at block 610, and the speed at which the driver 130 or cross belt 124 is being operated to determine a rate at which crop material is being discharged from the merger device 116. Using such information, the controller 152 can determine a rate or speed of travel for the agricultural vehicle 100 such that the quantity of crop material being discharged from the merger device 116 is being deposited in or on a windrow 102a, 102b in a manner that can provide the windrow profile that was identified at block 602. Such a determination of vehicle speed at block 620 can include determining the extent, if any, the current speed of the agricultural vehicle 100 is to be adjusted. Thus, according to certain embodiments, the speed determined by the controller at block 620 can be compared to the speed information provided by the vehicle speed sensor 166 to determine if, and the extent, the speed of the agricultural vehicle 100 is to be adjusted. The speed information determined that block 620 can then be used by the controller 152, including the processor 154, to generate a signal, such as, for example, for operation of the engine 112, so that the agricultural vehicle 100 travels at the speed that was determined at block 620. Additionally, the controller 152 can continuously monitor the rate at which crop material is being discharged from the merger device 116 in connection with determining whether adjustments and the speed of the agricultural vehicle 100 are to be made so as to maintain the selected windrow profile.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. An apparatus for estimating a throughput of a crop material, the apparatus comprising:
at least one conveyor having a conveyor belt and a driver, the driver adapted to provide a force for a rotational displacement of the conveyor belt;
a first sensor coupled to the at least one conveyor;
a memory device coupled with at least one processor, the memory device including instructions that when executed by the at least one processor cause the at least one processor to:
estimate, from information obtained by the first sensor, at least one of a weight and a mass of the crop material on the conveyor belt;
identify a speed at which the crop material is being conveyed by the at least one conveyor; and
estimate, using the weight or the mass of the crop material and the speed, the throughput of the crop material.

2. The apparatus of claim 1, wherein the driver is a hydraulic actuator, and the first sensor comprises a pressure sensor that is configured to detect a pressure of a hydraulic fluid.

3. The apparatus of claim 1, wherein the driver is an electric motor, and the first sensor is a load sensor.

4. The apparatus of claim 1, wherein the first sensor is a weight sensor that is coupled to the at least one conveyor.

5. The apparatus of claim 1, wherein the at least one processor estimates at least one of the weight and the mass of the crop material at least in part by comparing a first value provided by the first sensor to a second value second signal provided by the first sensor, the first value corresponding to information from the first sensor when the crop material is not on the conveyor belt.

6. The apparatus of claim 1, further including an optical sensor, and wherein the memory device further includes instructions that when executed by the at least one processor cause the at least one processor to estimate, using at least information provided by the optical sensor, at least one of a volume of the crop material on the conveyor belt or a volume of the crop material discharged from the at least one conveyor.

7. The apparatus of claim 6, wherein the memory device further includes instructions that when executed by the at least one processor cause the at least one processor to determine, using at least the weight or the mass and the volume estimated by the processor, a density of the crop material.

8. The apparatus of claim 6, wherein the optical sensor is an ultra-wideband radar system, and wherein the memory device further includes instructions that when executed by the at least one processor cause the at least one processor to determine, using information provided by the ultra-wideband radar system, a density of the crop material.

9. The apparatus of claim 1, wherein the memory device further includes instructions that when executed by the at least one processor cause the at least one processor to generate a signal for a display of the throughput estimation.

10. The apparatus of claim 1, wherein the memory device further includes instructions that when executed by the at least one processor cause the at least one processor to:
receive a calibration signal that provides at least information indicative of a characteristic or property of the crop material; and
calibrate, using information from the calibration signal, at least one of the throughput estimation or the information obtained by the first sensor.

11. An apparatus for controlling a speed at which a crop material is conveyed along the apparatus comprising:
at least one conveyor having a conveyor belt and a driver, the driver adapted to provide a force for a rotational displacement of the conveyor belt;
a first sensor coupled to the at least one conveyor;
a memory device coupled with at least one processor, the memory device including instructions that when executed by the at least one processor cause the at least one processor to:
estimate, from information obtained by the first sensor, at least one of a weight and a mass of the crop material on the conveyor belt;
identify a target location at which the crop material discharged from the at least one conveyor is to be deposited;
estimate, using at least one of the weight or the mass of the crop material and the target location, a speed to operate at least one of the driver and the conveyor belt; and
generate a signal to facilitate operation of at least one of the driver and the conveyor belt at the speed.

12. The apparatus of claim 11, wherein the driver is a hydraulic actuator, and the first sensor comprises a pressure sensor that is configured to detect a pressure of a hydraulic fluid.

13. The apparatus of claim 1, wherein the driver is an electric motor, and the first sensor is a load sensor.

14. The apparatus of claim 11, wherein the first sensor is a weight sensor that is coupled to the at least one conveyor.

15. The apparatus of claim 11, wherein the at least one processor estimates at least one of the weight or the mass of the crop material at least in part by comparing a first value from the first sensor to a second signal from the first sensor, the first value corresponding to information from the first sensor when the crop material is not on the conveyor belt.

16. The apparatus of claim 11, further including an optical sensor, and wherein the memory device further includes instructions that when executed by the at least one processor cause the at least one processor to estimate, using at least information provided by the optical sensor, at least one of a volume of the crop material on the conveyor belt or a volume of the crop material discharged from the at least one conveyor.

17. The apparatus of claim 16, wherein the memory device further includes instructions that when executed by the at least one processor cause the at least one processor to determine, using the volume estimated by the processor and at least one of the weight or the mass, a density of the crop material.

18. The apparatus of claim 16, wherein the optical sensor is an ultra-wideband radar system, and wherein the memory device further includes instructions that when executed by the at least one processor cause the at least one processor to determine, using information provided by the ultra-wideband radar system, a density of the crop material.

19. The apparatus of claim 11, wherein the memory device further includes instructions that when executed by the at least one processor cause the at least one processor to:
determine, from a location of the apparatus and the target location, a distance the crop material is to be displaced to reach the target location, and
wherein the at least one processor further estimates the speed at which at least one of the driver and the conveyor belt is to be operated based, at least in part, on the distance the crop material is to be displaced to reach the target location.

20. The apparatus of claim 19, wherein the target location is based, at least in part, on a location of a previously formed windrow.

21. The apparatus of claim 19, wherein the memory device further includes instructions that when executed by the at least one processor cause the at least one processor to:
receive a windrow parameter that provides at least information indicative of a profile of a windrow that is be formed, at least in part, from the crop material dispensed from the at least one conveyor; and
determine a travel speed of the apparatus based at least in part on the windrow parameter and the estimation of at least one of the weight or the mass of the crop material.
